(19) United States
(12) Patent Application Publication
(10) Pub. No.: US 2002/0183659 A1
(43) Pub. Date: Dec. 5, 2002

(54) Method and apparatus for promoting the healing of human tissue

(76) Inventor: Horst Ed Krause, Galveston, TX (US)

Correspondence Address: Harrison & Egbert, 7th Floor, 412 Main Street, Houston, TX, 77002, US

(21) Appl. No.: 09/873,112

(22) Filed: Jun. 4, 2001

(51) Int. Cl. A61H 7/00

(52) U.S. Cl. 601/6

(57) ABSTRACT

A method of promoting healing of an area of human tissue of a human body including placing the area of human tissue in a vacuum chamber, applying a receptor electrode to another area of the human body, transmitting a signal from the receptor electrode so as to produce a representation of a physiological cycle of the human body, and applying a vacuum within the vacuum chamber in timed relationship to the representation of the physiological cycle. The vacuum is applied for a desired period of time. The vacuum is released from the vacuum chamber subsequent to the desired period of time. Pressure of at least atmospheric pressure is introduced into the vacuum chamber subsequent to such desired period of time. The physiological cycle is a cardiac cycle.

### BACKGROUND OF THE INVENTION

1. Field of the Invention

The present invention relates to methods and apparatus for healing human tissues. More particularly, the present invention relates to methods and apparatus for promoting the healing of human tissue by the application of a vacuum to the tissue synchronous to a cardiac cycle or other events in the human body.

2. Description of Related Art

Wounds, skin ulcers and sores of various types and origins require a long time to heal. This healing time results in an equally long period of suffering and a corresponding increase in the cost of medical care. Often, these conditions do not respond to conventional treatment and sometimes lead to a permanent affliction. In some cases, the condition progresses until it becomes necessary to amputate the limb, as in the case of over 35,000 diabetics annually. The danger of permanent affliction or even death is present if response to treatment is poor and gangrenous infection sets in.

In the past, electrical nerve stimulation has been used for various therapeutic purposes, including the relief of otherwise intractable pain. In particular, electrical nerve stimulaters are widely used to induce the contraction of skeletal muscle groups and for the relief of pain by blocking nerve conduction. To accomplish, electrodes are placed near specific nerves either superficially, percutaneously, or by surgical implantation. The stimulation is accomplished by applying an electrical current to the electrodes. The current is applied in the form of a series of pulses. The duration of an individual pulse, the number of pulses in the series, the time interval of no stimulation after a stimulating pulse series, and the magnitude of the applied electrical current are, in general, variable and are adjusted by the attending physician, therapist or patients. It has been found that electrical nerve stimulation may be used so as to treat the human body. The electrical nerve stimulation can increase blood flow in ischemic areas and accelerate healing of ulcers of various etiology and ulcers that have not previously responded to conventional treatment.

The present inventor is presently the owner of U.S. Pat. No. 5,458,626, issued on Oct. 17, 1995 and entitled “Method of Electrical Nerve Stimulation for Acceleration of Tissue Healing”. In this patent, a method of electrical nerve stimulation for acceleration of tissue healing of a patient was described. This method included the steps of applying a receptor electrode to an area of body of the patient, actuating a stimulating electrode to another area of the body of the patient, transmitting a signal from the receptor electrode to a monitor so as to produce a representation of a physiological cycle of the patient, and passing an electrical pulse to the stimulating electrode in timed relationship to the representation of the physiological cycle. In particular, in this patent, the physiological cycle was a cardiac cycle having a systolic period and a diastolic period. The electrical pulses were passed during the systolic period of the cardiac cycle.

In certain circumstances, the healing of human tissue has been carried out in hyberbaric chambers and hypobaric chambers. A patient is placed in such a chamber and then the application of pressures above atmospheric or the application of vacuum pressures are applied to the patient in a continuous manner. Although such chambers have indicated some success in the promotion of the healing of such tissues, the use of such chambers has not found widespread acceptance in the treatment of such wounds, skin ulcers and sores. Furthermore, these hyberbaric chambers and hypobaric chambers are relatively expensive and require that the patient spend a very extended period of time in such pressurized or vacuum conditions. These chambers do not carry out any actions with respect to a human physiological cycle.

It is an object of the present invention to provide a method and apparatus for the acceleration of tissue healing.

It is another object of the present invention to provide a method for increasing blood flow through such tissues.

It is still another object of the present invention to provide a method and apparatus that correlates the application of vacuum and pressure conditions to the afflicted area in relation to the action of the heart in the pumping of the cardiovascular system. It is still a further object of the present invention to provide a method and apparatus for promoting tissue healing which can be applied to the specific areas of the human body.

It is still a further object of the present invention to provide a method and apparatus for promoting the healing of human tissue which is relatively inexpensive, easy to use, and does not require the patient to be incapacitated for an extended period of time.

These and other objects and advantages of the present invention will become apparent from a reading of the attached specification and appended claims.

### BRIEF SUMMARY OF THE INVENTION

The present invention is a method of promoting the healing of an area of human tissue of a human body comprising the steps of: (1) placing the area of human tissue in a vacuum chamber; (2) applying a receptor electrode to an area of the human body; (3) transmitting a signal from the receptor electrode so as to produce a representation of a physiological cycle of the human body; and (4) applying a vacuum within the vacuum chamber in timed relationship to the representation of the physiological cycle.

In the present invention, the step of applying a vacuum is for a limited period of time. The vacuum is released from the vacuum chamber subsequent to such period of time. Pressure of at least atmospheric pressure can be introduced into the vacuum chamber subsequent to such limited period of time. The vacuum chamber can be pressured with air pressure above atmospheric pressure.

A vacuum source is connected to the vacuum chamber. A control circuit is connected to the receptor electrode so as to be interactive with the vacuum source. A signal is actuated from the control circuit so as to actuate a valve between the vacuum source and the vacuum chamber. Air is then evacuated from the vacuum chamber by the vacuum source so as to produce the vacuum within the vacuum chamber.

In the present invention, the physiological cycle is a cardiac cycle having a systolic period and a diastolic period. The step of applying a vacuum includes applying the vacuum at least during the systolic period. The vacuum can also be applied during a portion of the diastolic period. Pressure is applied by introducing air into the vacuum chamber during another portion of the diastolic period.

In the present invention, the receptor electrodes are connected to a control circuit. This control circuit is, in turn, connected to a control valve. The vacuum source is also connected to the control valve. An air pressure source is further connected to the control valve. The step of applying a vacuum includes actuating the control valve such that the vacuum source communicates with the vacuum chamber. Air is introduced into the vacuum chamber after the step of applying a vacuum. The control valve is actuated such that the vacuum source is blocked from communication with the vacuum chamber and such that the pressure source communicates with the vacuum chamber. The control valve is also actuated such that the pressure source is blocked from communication with the vacuum chamber.

The present invention is also an apparatus for promoting the healing of human tissue comprising a vacuum chamber, a receptor electrode means for receiving signals relative to a physiological cycle of the human body, and a vacuum source means interconnected to the receptor electrode means for producing a vacuum in the vacuum chamber for a limited period of time in relation to a portion of the physiological cycle. A control circuit means is connected to the receptor electrode means for producing a control signal in relation to the portion of the physiological cycle. A valve means is connected between the vacuum chamber and the vacuum source means. The valve means is interconnected to the control circuit means. The valve means serves to open or to block communication between the vacuum source means and the vacuum chamber relative to the control signal. A pressure source means is connected to the valve means. The pressure source means is for introducing air into the vacuum chamber. The valve means serves to open or to block communication between the vacuum chamber and the pressure source means relative to the control signal. The vacuum chamber has an interior area suitable for receiving a portion of the human body therein.

### BRIEF DESCRIPTION OF THE SEVERAL VIEWS OF THE DRAWINGS

FIG. 1 is a schematic illustration of the method of the present invention.

FIG. 2 is a multiple graphical illustration of the method of the present invention in relation to aortic pressure and the ECG graph.

### DETAILED DESCRIPTION OF THE INVENTION

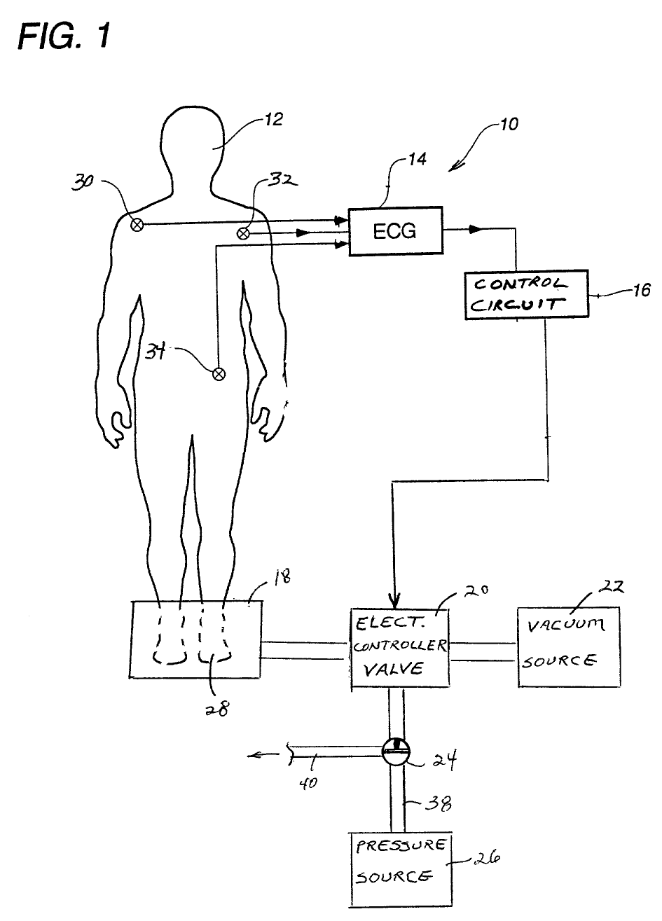

Referring to FIG. 1, there is shown the system 10 of the present invention for promoting the healing of tissues of the patient 12. The system 10 includes the ECG 14, a control circuit 16, a vacuum chamber 18, an electronic controller valve 20, a vacuum source 22, a three-way valve 24 and a pressure source 26. Each of these elements are interactive so as to provide the required vacuum and pressure effects for the purpose of healing the tissue of the patient 12, particularly the tissue associated with the feet 28 of the patient 12 located within the vacuum chamber 18.

Initially, the receptor electrodes 30, 32 and 34 are applied to the patient 12. The purpose of the electrodes 30, 32 and 34 is to transmit electrical signals generated by the heart and to communicate such signals to the electrocardiograph via the connecting cables. Within the scope of the present invention, a single receptor electrode could be used. However, in the preferred embodiment of the present invention, a plurality of such electrodes are used so as to provide a representative reading to the electrocardiograph.

The electrodes 30, 32 and 34 sense the potential of the electrical currents generated by the heart and communicate these potentials to the electrocardiograph 14. The electrocardiograph amplifies these potentials greatly. These potentials will vary in magnitude during the course of the cardiac cycle.

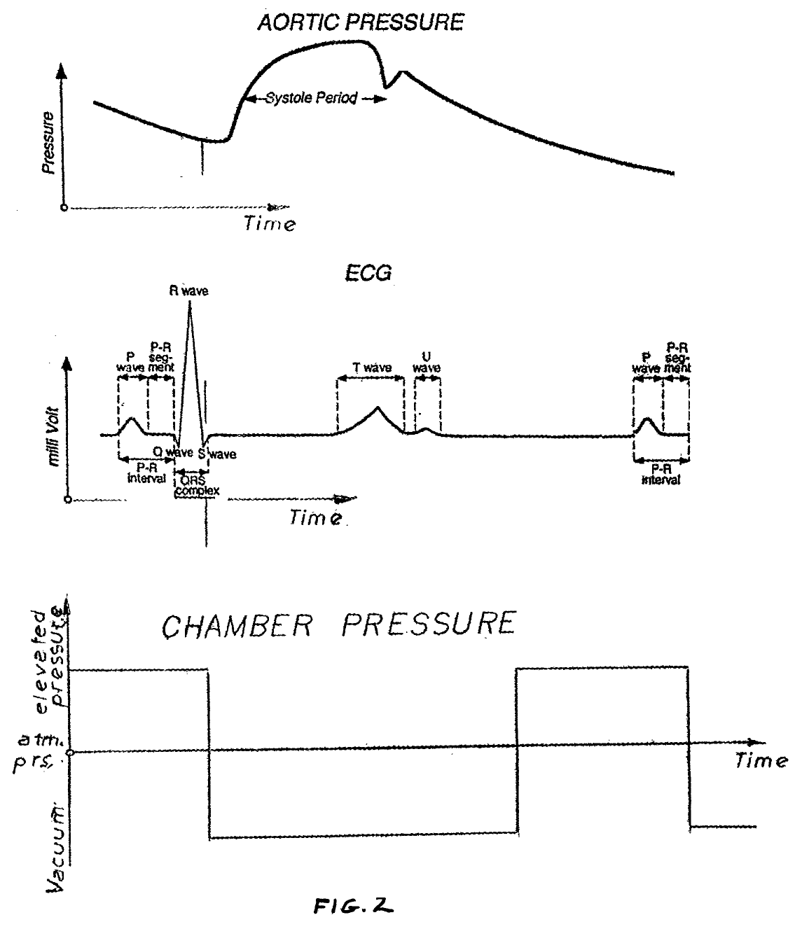

The electrocardiograph 14 will produce a graphic recording of the cardiac cycle in an electrocardiogram. FIG. 2 illustrates such an ECG, together with the simultaneously occurring variation of the aortic pressure during the course of the same cardiac cycle. With reference fee to FIG. 2, it can be seen that the electrocardiograph is composed of three very distinct events. These events are the P wave, the so-called QRS complex, and the T wave. The P wave occurs at the beginning of each contraction of the atria. The QRS complex begins at the beginning of each contraction of the ventricles. The T wave occurs as the ventricles recover electrically and prepare for the next contraction. It is therefor apparent that these distinct features of the ECG 14 are uniquely related to the pumping action of the heart and, as a consequence, uniquely related to the variations of the blood pressure and blood flow during the course of one cardiac cycle. In FIG. 2, it can be seen that the systolic period corresponds generally to the period between the end of the QRS complex and the peak of the T wave.

In the preferred embodiment of the present invention, the electrocardiograph 14 provides the ECG as an electrical input to the control circuit 16. It is evident from an inspection of the ECG in FIG. 2 that considerable and characteristic variations occur that are typical for certain portions and instances within one cardiac cycle. For example, the peak voltages of all three above-mentioned sections (P wave, QRS complex, T wave) are significantly different. Secondly, the slope of the QRS complex, for instance, differs considerably from that of the P wave or the T wave. The slopes, as well as the voltages, assume both positive and negative values during the course of the cardiac cycle. Therefore, the peak of a wave, the combination of a voltage and the simultaneously existing rate of its change (slope) are only a voltage, should be characteristic for most instances during these three segments and can therefor be used to identify the instantaneous status of the ventricles within a cardiac cycle. The possibility of an ambiguity of identification can be reduced by also considering a third variable, besides instantaneous voltage and slope. Such a variable could be the time interval between the occurrence of a very distinct and unique point, such as the greatest negative voltage proceeded by a sharp negative slopes followed by a sharp positive slope (also designated as the Q instant) and the voltage and slope at the instant of recording. Various algorithms, including such variables as inputs, as well as sophisticated mathematical transforms, filtering, correlation and signaling identification methods, can be utilized to numerically correlate pertinent instances as to their position within the period of one cardiac cycle.

The control circuit 16 is a processor which will receive the ECG 14 as an input and process it in the manner described above so as to activate the electronic controller valve 20 at the desired instant and for the desired period of time. The control circuit 16 can be suitably manipulate the electronic controller valve 20 so as to allow the vacuum source 20 to communicate with the vacuum chamber 18 or to allow the pressure source 26 to communicate with the vacuum chamber 18 in timed response. For example, in one position, the controller valve 20 will allow the vacuum source to communicate with the vacuum chamber 14 for the purpose of inducing a vacuum into the chamber 14. The controller valve 20 will block any pressure from the pressure source 26, or from atmospheric pressure, from entering the vacuum chamber 18. As a result, the vacuum source 22 is free to introduce a significant vacuum into the interior of the vacuum chamber 14. The controller valve 20 can also be activated by the control circuit so as to block the vacuum source 22 from communication with the vacuum chamber 18 and to allow the pressure source 26 to introduce air pressure into the interior of the vacuum chamber 18. A three-way valve 24 is introduced on the line 38 between the pressure source and the controller valve 20 so as to allow for the evacuation of air pressure along line 40 to the atmosphere. Alternatively, the three-way valve 24 can be suitably activated so that the atmospheric air pressure is introduced into the interior of the vacuum chamber 18.

In the present invention, the cardiac cycle will have a systolic period and a diastolic period. The control circuit 16 will send a control signal to the control valve 20 at the beginning of the systolic period of the cardiac cycle so as to cause the vacuum source 22 to communicate with the interior of the vacuum chamber 18. Vacuum pressure is applied during the entirety of the systolic period and into a portion of the diastolic period. After the period of time during which the vacuum source is applied to the vacuum chamber 18, the control circuit 16 can transmit a control signal to the valve 20 so as to block the vacuum source 22 to the vacuum chamber 18 and to allow for the introduction of air pressure into the interior of the vacuum chamber 18. Subsequent to the diastolic period, the control circuit 16 can send another signal to the controller valve 20 so as to block the pressure source 26 from delivery of air pressure into the vacuum chamber 18 and to open the communication between the vacuum source 22 and the vacuum chamber 18. The control circuit 16 can be suitably programmed so as to pass triggering pulses repeatedly at identical instances during the subsequent cardiac cycle.

The operation of the present invention is particularly shown in FIG. 2. In FIG. 2, it can be seen that elevated pressures are applied during a portion of the diastolic period of the cardiac cycle. The vacuum condition is applied during the systolic period and also a portion of the diastolic period. The square wave pattern shown in the graph of FIG. 2 illustrates, in a dramatic manner, how the pressure and the vacuum are alternately applied during the cardiac cycle. As such, the present invention is able to restore normal blood flow in ischemic areas, such as trophic lesions for the purpose of promoting and augmenting the healing process.

Blood flow is increased by placing the affected body area, such as feet 28, within the vacuum chamber 18. The pressure within the vacuum chamber 18 is cycled between a vacuum condition and an atmospheric (or above atmospheric pressure) by connecting the vacuum chamber 18 alternately to the vacuum source 22 or to the pressure source 26 (or to open air). The electronically controlled valve 20 (i.e. a solenoid valve) will alternately connect the vacuum chamber 18 to either the vacuum source 22 or the pressure source 26. The electronically controlled valve 20 receives its command input from the control circuit 16. The control circuit 16 serves the purpose to synchronize the electronic controller valve 20 to certain events during the cardiac cycle. Therefore, the control circuit 16 receives its input from the ECG 14 and from the electrodes 30, 32 and 34 that are placed on the body of the patient 12.

The preferred application of the method of the present invention is to produce a blood pumping action within the diseased tissue area of the patient 12. This can be achieved by producing a vacuum condition during the systolic period and partially during the diastolic period of the cardiac cycle. The vacuum expands the lumen of the blood vessel through the reduced extra-vascular pressure. Following this period, the pressure in the vacuum chamber is returned to atmospheric pressure or above in order to compress the blood vessel somewhat and to drive its blood content so as to return to the heart and to provide vascular space to be filled up with fresh arterial blood during the following cardiac cycle. During the onset of the systolic period, the cycle will be repeated by opening the vacuum chamber 18 to the vacuum source 22.

It is to be noted that, within the concept of the present invention, various vacuum/pressure sequences can be employed. After experimentation, it is possible that pressure during the systolic period and vacuum during the diastolic period can facilitate healing in some cases. It is also possible that repeated pressure/vacuum cycles during the time span of one cardiac cycle may have some merit. The control circuit 16 can be suitably programmed so as to apply a variety of pressure/pulse shapes.

The foregoing disclosure and description of the invention is illustrative and explanatory thereof. Various changes in the details of the illustrated construction may be made within the scope of the appended claims without departing from the true spirit of the invention. The present invention should only be limited by the following claims and their legal equivalents.

I claim:

1. A method of promoting the healing of an area of human tissue of a human body comprising:
placing the area of human tissue in a vacuum chamber;
applying a receptor electrode to an area of the human body;
transmitting a signal from said receptor electrode so as to produce a representation of a physiological cycle of the human body; and
applying a vacuum within said vacuum chamber in timed relationship to said representation of said physiological cycle.

2. The method of claim 1, said step of applying a vacuum being for a limited period of time, the method further comprising the step of:
releasing said vacuum from said vacuum chamber subsequent to said limited period of time.

3. The method of claim 2, further comprising:
introducing a pressure of at least atmospheric pressure subsequent to said period of time.

4. The method of claim 3, said step of introducing a pressure comprising:
pressurizing said vacuum chamber with an air pressure above atmospheric pressure.

5. The method of claim 1, further comprising:
connecting a vacuum source to said vacuum chamber; and
interconnecting a controller to said receptor electrode, said controller being interactive with said vacuum source.

6. The method of claim 5, said step of applying a vacuum comprising:
actuating a signal from said controller so as to actuate a valve between said vacuum source and said vacuum chamber; and
evacuating air from said vacuum chamber by said vacuum source so as to produce said vacuum.

7. The method of claim 1, said physiological cycle being a cardiac cycle having a systolic period and a diastolic period, said step of applying a vacuum comprising:
applying said vacuum at least during said systolic period.

8. The method of claim 7, said step of applying a vacuum comprising:
applying said vacuum during said systolic period and during a portion of said diastolic period.

9. The method of claim 7, further comprising:
introducing air into said vacuum chamber during a portion of said diastolic period.

10. The method of claim 9, said step of introducing air comprising:
applying an air pressure above atmospheric into said vacuum chamber.

11. The method of claim 1, further comprising:
interconnecting said receptor electrode to a controller;
connecting said controller to a control valve;
connecting a vacuum source to said control valve; and
connecting an air pressure source to said control valve.

12. The method of claim 11, said step of applying a vacuum comprising:
actuating said control valve such that said vacuum source communicates with said vacuum chamber.

13. The method of claim 12, further comprising:
introducing air into said vacuum chamber after said step of applying a vacuum, said step of introducing air comprising actuating said control valve such that said vacuum source is blocked from communication with said vacuum chamber and such that said pressure source communicates with said vacuum chamber.

14. The method of claim 13, said step of applying a vacuum comprising:
actuating said control valve such that said pressure source is blocked from communication with said vacuum chamber.

15. The method of claim 1, said step of transmitting a signal comprising:
connecting said receptor electrode to an electrocardiograph;
amplifying an electrical signal from said receptor electrode so as to produce a representation of a cardiac cycle; and
creating a graphical illustration of the cardiac cycle, said step of applying a vacuum comprising applying said vacuum for a limited period of time relative to the representation of the cardiac cycle.

16. An apparatus for promoting healing of human tissue comprising:
a vacuum chamber;
a receptor electrode means for receiving signals relative to a physiological cycle of a human body; and
a vacuum source means interconnected to said receptor electrode means for producing a vacuum in said vacuum chamber for a limited period of time in relation to a portion of said physiological cycle.

17. The apparatus of claim 16, further comprising:
a control circuit means connected to said receptor electrode means for producing a control signal in relation to said portion of said physiological cycle; and
a valve means connected between said vacuum chamber and said vacuum source means, said valve means being connected to said control circuit means, said valve means for opening and blocking communication between said vacuum source means and said vacuum chamber relative to said control signal.

18. The apparatus of claim 17, further comprising:
a pressure source means connected to said valve means, said pressure source means for introducing air into said vacuum chamber, said valve means for opening and blocking communication between said vacuum chamber and said pressure source means relative to said control signal.

19. The apparatus of claim 16, said physiological cycle being a cardiac cycle having a systolic period and a diastolic period, said vacuum source means for producing a vacuum in said vacuum chamber at least during said systolic period.

20. The apparatus of claim 16, said vacuum chamber having an interior area suitable for receiving a portion of the human body therein.
